(19) United States
(12) Patent Application Publication
(10) Pub. No.: US 2013/0111536 A1
(43) Pub. Date: May 2, 2013

(54) TERMINAL ADAPTER FOR ENABLING NON-IP-ENCAPSULATED VIDEOS TO BE RECEIVED AT SUBSCRIBER PREMISES FOR PLAYBACK ON AN IP DEVICES

(71) Applicants: Bruce McClelland, Suwanee, GA (US); Chad Lord, Sugar Hill, GA (US); Wade E. Carter, Johns Creek, GA (US)

(72) Inventors: Bruce McClelland, Suwanee, GA (US); Chad Lord, Sugar Hill, GA (US); Wade E. Carter, Johns Creek, GA (US)

(21) Appl. No.: 13/283,030

(22) Filed: Oct. 27, 2011

(51) Int. Cl. H04N 21/60

(52) U.S. Cl. 725/110; 725/109

(57) ABSTRACT

Methods and apparatuses for enabling non-IP-encapsulated videos to be received at subscriber premises and displayed on IP playback devices are provided. A terminal adapter receives a non-IP-encapsulated video at a subscriber premise and transcodes the video to a format that can be processed by the IP playback device. The terminal adapter IP-encapsulates the transcoded video and then routes the IP-encapsulated video to the IP playback device. In this way, the processing to convert non-IP-encapsulated videos stored on video servers is not concentrated at a central location but instead distributed across subscriber premises. Furthermore, congestion on the downstream link can be reduced because videos in a video server are not required to be transmitted downstream under two different schemes.

### TECHNICAL FIELD

This disclosure relates to playback of non-IP-encapsulated videos received at subscriber premises on IP devices.

### BACKGROUND

FIG. 1 illustrates a high-level general system 100 for distributing videos from various video sources to various playback devices over a network environment.

For example, a video 105 stored on an Internet Protocol (IP) server 110 can be delivered from the IP server 110 to a destination IP playback device 180 (such as a mobile phone) over an IP network 120 and then a cable-based network 150. The video 105 stored on the IP server 110 typically is processed using either a MPEG-2 or a MPEG-4 codec to produce an MPEG transport stream. The MPEG transport stream then is IP-encapsulated, and the IP-encapsulated MPEG video (“IP/MPEG video”) 115 is transported over the IP network 120 to a cable headend 130.

In the headend 130, IP/MPEG video 115′ representing the IP/MPEG video 115 can be received by a CMTS 132 or EQAM 134 device and converted to a QAM signal 135 representing the video (“QAM/IP/MPEG signal 135”), for example, for delivery over the cabled based network 150. The QAM/IP/MPEG signal 135 output from the CMTS or EQAM device can occupy a specific band-limited channel (e.g., a 6 MHz and/ or 8 MHz-wide channel) having a center frequency that falls within a designated frequency range. The QAM/IP/MPEG signal 135 can then be combined with signals for other services (e.g., voice, non-video high speed data) to produce a combined signal 137. The combined signal 137, which includes the QAM/IP/MPEG signal 135, then can be transmitted over the cable-based network 150 to a subscriber premise. The cable network 130 can take the form of an all-coax, all-fiber, or hybrid fiber/coax (HFC) network, for example.

At the subscriber premise, a combined signal 137′ representing the combined signal 137 can be received by a cable modem (CM) 170 and the IP/MPEG video 115′ representing the IP/MPEG video 115 can be delivered to the IP playback device 180 to process and display the video 105′ representing video 105. Other services (such as high speed data, for example) included in the combined signal 137′ can be delivered to other CPE devices (such as a personal computer 175).

As another example, a video 142 stored on a video server 140 at the headend 130 can be delivered over the cable-based network 150 to a subscriber premise where it is received by a television 165 via a settop box 160. The video 142 stored on the video server 140 typically is processed using either a MPEG-2 or a MPEG-4 codec to produce an MPEG transport stream. The MPEG transport stream 144 then is QAM modulated by an EQAM device 145 to produce a QAM/MPEG signal 147 representing the video 142 for delivery over the cabled based network 150.

The QAM/MPEG signal 147 can occupy a specific band-limited channel (e.g., a 6 MHz and/or 8 MHz-wide channel) having a center frequency that falls within a designated frequency range. The QAM/MPEG signal 147 can then be combined with signals from other services (e.g., QAM/IP/MPEG signal 135 or other signals) to produce a combined signal such as combined signal 137. The combined signal 137, which includes the QAM/MPEG signal 147, then can be transmitted over the cable-based network 150 to a subscriber premise.

At the subscriber premise, a combined signal 137″ representing the combined signal 137 can be received by a settop box 160 where the MPEG video 144′ representing the MPEG video 144 is delivered to the television 165 to process and display the video 142′ representing video 142.

It is noted that the QAM/MPEG signal 147 cannot be processed by an IP playback device (such as IP playback device 180) because the QAM/MPEG signal 147 is not in the proper format (for example, it is not IP-encapsulated) for the IP playback device to process and display the video represented by the MPEG/QAM signal 147.

Thus, to playback non-IP-encapsulated video (such as the video 142 stored on video server 140) on an IP playback device, existing cable-based systems IP-encapsulate the video 142 using an IP-encapsulator 155. Then, similar to the IP/MPEG video 115′, the IP/MPEG video 157 from IP-encapsulator 155 can be processed for delivery over the cabled-based network 150 by a CMTS 132 or EQAM 134 device in the headend 130 to produce a QAM/IP/MPEG signal 139. The QAM/IP/MPEG signal 139 output from the CMTS or EQAM device can occupy a specific band-limited channel (e.g., a 6 MHz and/or 8 MHz-wide channel) having a center frequency that falls within a designated frequency range. The QAM/IP/MPEG signal 139 can then be combined with signals from other services (e.g., QAM/IP/MPEG signal 135, QAM/ MPEG signal 147 and/ or other signals) to produce a combined signal such as combined signal 137. The combined signal 137, which includes the QAM/IP/MPEG signal 139, then can be transmitted over the cable-based network 150 to a subscriber premise.

At the subscriber premise such as the subscriber premise having the IP playback device 180, for example, the combined signal 137′ representing the combined signal 137 can be received by the CM 170 and the IP/MPEG video 157′ representing the IP/MPEG video 157 is delivered to the IP playback device 180 to process and display the video 142″representing video 142.

In this way, a non-IP-encapsulated video (such as video 142) stored on a video server can be received and displayed on an IP playback device.

End users increasingly desire to receive and watch videos on IP playback devices (such as mobile devices including mobile phones, tablets, netbook, or notebook computers). Thus, cable operators are increasingly delivering videos downstream as QAM/IP/MPEG signals (such as QAM/IP/MPEG signal 139) to be received and displayed by IP playback devices. However, producing QAM/IP/MPEG signals for transferring non-IP-encapsulated videos stored on video servers (such as the video 142 stored on video server 140) downstream to be processed by IP playback devices is computational intensive. Furthermore, producing and transferring these QAM/IP/MPEG signals downstream can cause congestion on the downstream link and is inefficient since the videos also are delivered downstream as QAM/MPEG signals (such MPEG/QAM signal 147).

### BRIEF DESCRIPTION OF THE DRAWINGS

FIG. 1 is a block diagram illustrating a high-level general system for distributing videos from various video sources to various playback devices over a network environment.

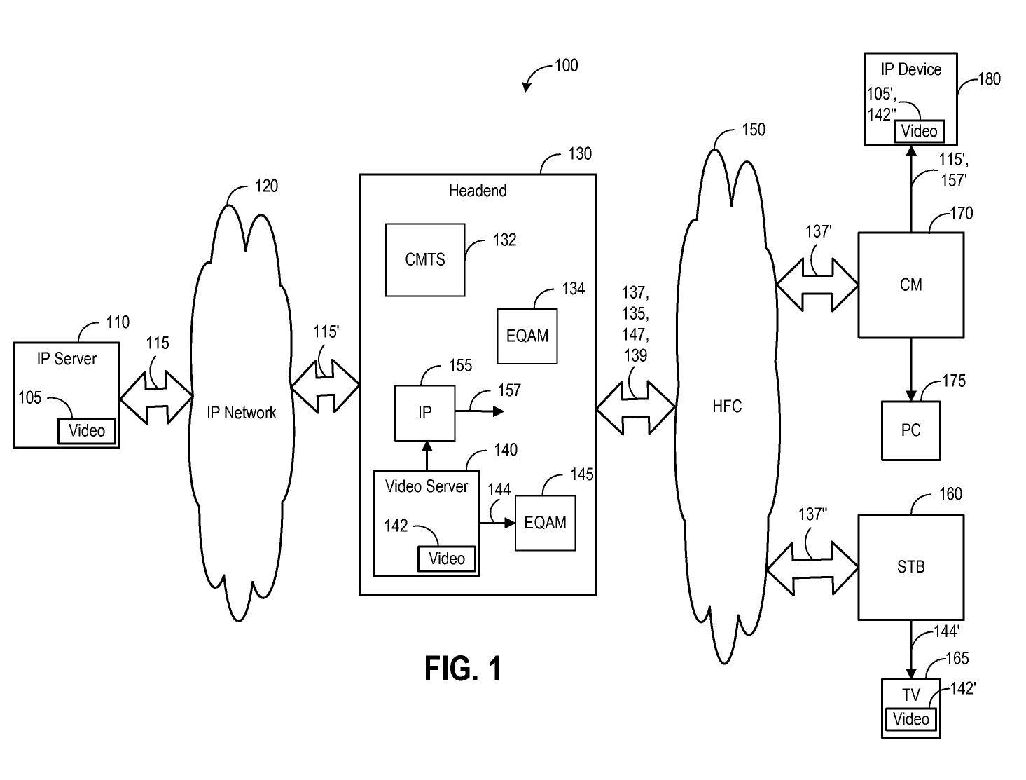

FIG. 2 is a block diagram illustrating an example system for distributing a non-IP-encapsulated video stored on a video server over a cable-based system to an IP playback device.

FIG. 3 is a block diagram illustrating an example terminal adapter for enabling a non-IP-encapsulated video to be received at subscriber premise and displayed by an IP playback device.

### DETAILED DESCRIPTION

Various implementations of this disclosure provide apparatuses and methods that may more efficiently enable non-IP-encapsulated videos stored on a video server to be received and displayed on IP playback devices at subscriber premises. The apparatuses and methods of the present disclosure transfer a non-IP-encapsulated video stored on a video server over a cable-based system to a terminal adapter at a subscriber premise where the terminal adapter can transcode the video to a format that can be processed by an IP playback device, IP-encapsulate the transcoded video, and then route the IP-encapsulated video to the IP playback device. In this way, the processing to convert non-IP-encapsulated videos stored on video servers is not concentrated at a central location but instead distributed across subscriber premises. Furthermore, with the apparatuses and methods of the present disclosure, videos in a video server are not transmitted downstream under two different schemes, as discussed above, which can help avoid congestion on the downstream link.

Although this disclosure makes reference to a cable-based system, this disclosure is not intended to be limited to cable-based networks. It should be understood that the concepts disclosed herein can be applied to any access network including any wired or wireless network or a combination of the foregoing. For example, the concepts disclosed herein can be applied to a telephone network, which can include twisted pair (wire) communications medium, using various Digital Subscriber Line (xDSL) technologies.

Furthermore, although this disclosure makes reference to non-IP-encapsulated videos, it should be understood that the concepts disclosed herein can be applied to non--IP-encapsulated data in general.

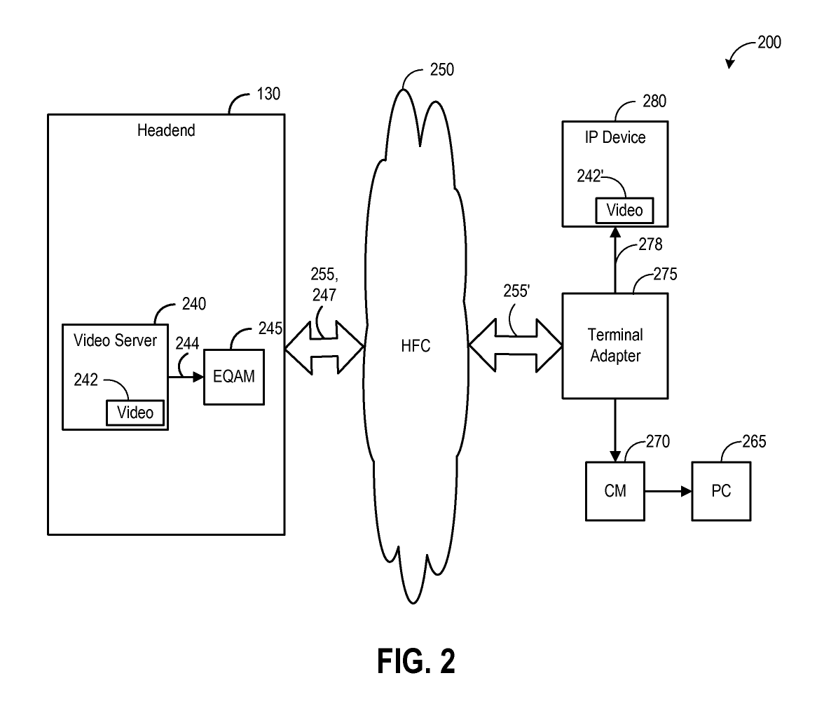

FIG. 2 illustrates an example system 200 for distributing a non-IP-encapsulated video stored on a video server over a cable-based system to an IP playback device.

As discussed above, a video 242 stored in the video server 240 can be processed using either a MPEG-2 or a MPEG-4 codec, for example, to produce an MPEG transport stream. Although this example implementation makes reference to MPEG-2 and a MPEG-4 codecs, this disclosure is not limited to MPEG-2 or a MPEG-4 codecs. It should be understood that the concepts disclosed herein can be applied to any video encoder.

The MPEG transport stream 244 then is QAM modulated by an EQAM device 245 to produce a QAM/MPEG signal 247 representing the video 242 for delivery over the cabled-based network 250.

The QAM/MPEG signal 247 can occupy a specific band-limited channel (e.g., a 6 MHz and/or 8 MHz-wide channel) having a center frequency that falls within a designated frequency range. The QAM/MPEG signal 247 can then be combined with signals from other services (e.g., voice, non-video high speed data, and/or video signals such as QAM/IP/MPEG signal 135) to produce a combined signal 255. The combined signal 255, which includes the QAM/MPEG signal 247, then can be transmitted over the cable-based network 150 to a subscriber premise.

As noted above, the QAM/MPEG signal 247 cannot be processed by an IP playback device because the QAM/MPEG signal 247 is not in the proper format (for example, it is not IP-encapsulated) for the IP playback device to process and display the video represented by the QAM/MPEG signal 247.

Thus, to playback the video represented by the QAM/MPEG signal 247 on an IP playback device, a terminal adapter 275 can receive a combined signal 255′ representing the combined signal 255 transmitted from the headend 130. In the terminal adapter 275, the MPEG video 244′ representing the MPEG video 244 for the video to be played on the IP playback device 280 is extracted and formatted (e.g., transcoded and IP-encapsulated) for processing by the IP playback device 280. The properly formatted video 278 then can be delivered (e.g., directly or indirectly, wirelessly or wired, or a combination of the foregoing) to the IP playback device 280 to display the video 242′ representing video 242.

The terminal adapter 275 can also provide a copy of the combined signal 255′ to CM 270 for delivery of other services (such as high speed data) included in the combined signal 255′ to other CPE devices (such as a personal computer 265).

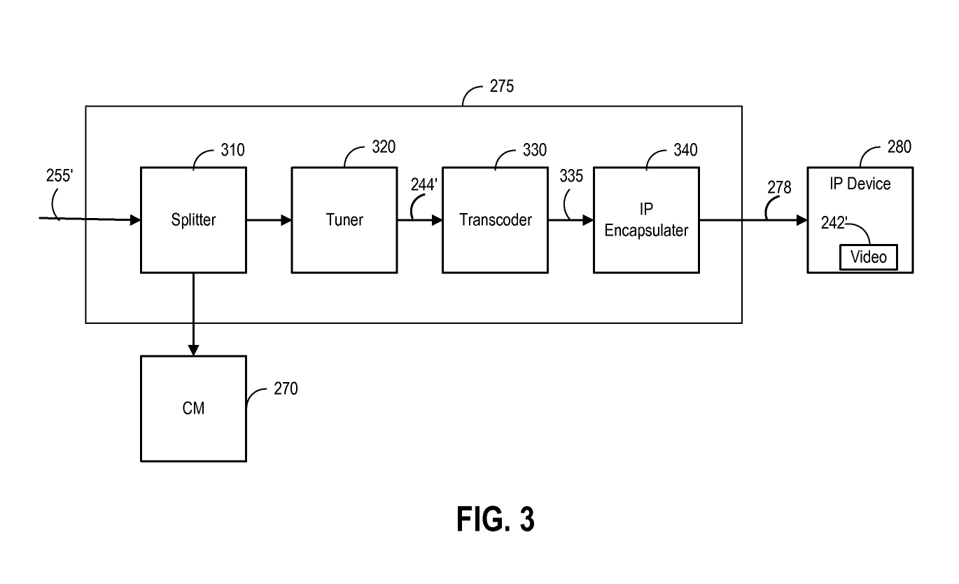

FIG. 3 illustrates an example terminal adapter 275 for enabling a non-IP-encapsulated video to be received at subscriber premise and displayed by an IP playback device.

The combined signal 255′ can be received by a splitter 310 which delivers a first copy of the combined signal 255′ to the CM 270. A second copy of the combined signal 255′ is received by a QAM tuner 320 to extract the MPEG transport stream 244′ representing the MPEG transport stream 244 for the video to be played on the IP playback device 280. The MPEG transport stream 244′ can then be transcoded by transcoder 330 to convert the MPEG transport stream 244′ to an appropriate format. For example, in some implementations the transcoder 330 can transcode the MPEG transport stream 244′ from MPEG-2 to MPEG-4. The transcoded video 335 can then be IP-encapsulated by IP encapsulator 340, and the properly formatted video 278 then can be delivered to the IP playback device 280 to display the video 242′ representing video 242.

By providing a splitter 310 in the terminal adapter 275 to deliver the downstream signal 255′ to an existing CPE device (such as CM 270), a subscriber premise can be easily upgraded to enable non-IP-encapsulated videos to be received and displayed by IP playback devices.

Furthermore, providing terminal adapters at subscriber premises distributes the processing to convert non-IP-encapsulated videos stored on video servers to IP-encapsulated videos across subscriber premises thereby alleviating the headend from performing such a computationally intensive process.

Still further, by providing terminal adapters at subscriber premises to enable non-IP-encapsulated videos to be received at the subscriber premise and displayed on IP playback devices, congestion on the downstream link can be reduced since videos in the video server are no longer required to be transmitted downstream under two different schemes, as discussed above.

Implementations of the devices of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for enabling a non-IP-encapsulated video to be received at a subscriber premise and displayed on an IP playback device, the method comprising:
receiving a multi-channel signal at a subscriber premise wherein the multi-channel signal includes a non-IP-encapsulated video on a first channel;
extracting the non-IP-encapsulated video on the first channel;
IP-encapsulating the non-IP-encapsulated video; and
delivering the IP-encapsulated video to an IP playback device.

2. The method of claim 1 further comprising transcoding the non-IP-encapsulated video.

3. The method of claim 2 wherein the non-IP-encapsulated video is transcoded from a first format to a second format.

4. The method of claim 3 wherein the first format is MPEG-2 and the second format is MPEG-4.

5. The method of claim 1 further comprising delivering a copy of the multi-channel signal to a CPE device.

6. The method of claim 5 wherein the CPE device is a cable modem.

7. The method of claim 1 wherein the non-IP-encapsulated video is QAM modulated.

8. The method of claim 1 wherein delivering the IP-encapsulated video to an IP playback device comprises directly or indirectly delivering the IP-encapsulated video to an IP playback device.

9. The method of claim 8 wherein delivering the IP-encapsulated video to an IP playback device comprises delivering the IP-encapsulated video to an IP playback device wireless or wired.

10. A terminal adapter for enabling a non-IP-encapsulated video to be received at a subscriber premise and displayed on an IP playback device comprising:
a receiver configured to receive a multi-channel signal wherein the multi-channel signal includes a non-IP-encapsulated video on a first channel;
a tuner configured to extract the non-IP-encapsulated video on the first channel; and
a processor configured to IP-encapsulate the non-IP-encapsulated video.

11. The terminal adaptor of claim 10 further comprising a splitter configured to receive the multi-channel signal and produce a first copy of the multi-channel signal and a second copy of the multi-channel signal.

12. The terminal adapter of claim 10 further comprising a transcoder to convert the non-IP-encapsulated video from a first format to a second format.

13. The terminal adapter of claim 10 wherein the non-IP-encapsulated video is QAM modulated.

14. A method for upgrading a subscriber premise to enable a non-IP-encapsulated video to be received at a subscriber premise and displayed on an IP playback device, the method comprising:
connecting a terminal adapter to a network to receive from the network a multi-channel signal wherein the multi-channel signal includes a non-IP-encapsulated video on a first channel and wherein the terminal adapter is configured to extract and format the non-IP-encapsulated video on the first channel for processing by an IP playback device;
connecting an output of the terminal adapter to a CPE device;
delivering a copy of the multi-channel signal from the terminal adapter to the CPE device; and
delivering the formatted video to the IP playback device.

15. A method for upgrading a subscriber premise to enable a non-IP-encapsulated video to be received at a subscriber premise and displayed on an IP playback device, the method comprising:
providing a terminal adapter to be connected to a network to receive from the network a multi-channel signal and to be connected to a CPE device;
wherein the multi-channel signal includes a non-IP-encapsulated video on a first channel; and
wherein the terminal adapter is configured to deliver a copy of the multi-channel signal to the CPE device and configured to extract and format the non-IP-encapsulated video for processing by an IP playback device.

16. A method for distributing processing of non-IP-encapsulated videos over a plurality of subscriber premises, the method comprising:
providing a plurality of terminal adapters at a plurality of subscriber premises, respectively, wherein each of the plurality of terminal adapters is configured to receive non-IP-encapsulated videos and format the non-IP-encapsulated videos for processing by an IP playback device.

17. A method for enabling non-IP-encapsulated data to be received at a subscriber premise and processed on an IP playback device, the method comprising:
receiving non-IP-encapsulated data;
IP-encapsulating the non-IP-encapsulated data; and
delivering the IP-encapsulated data to an IP playback device over a home network.
